(19) United States
(12) Patent Application Publication
(10) Pub. No.: US 2024/0343242 A1
(43) Pub. Date: Oct. 17, 2024

(54) SYSTEM FOR ESTIMATING BRAKE PAD WEAR AND METHOD FOR ESTIMATING BRAKE PAD WEAR

(71) Applicant: ZF CV Systems Global GmbH, Bern (CH)

(72) Inventor: Mehmet Yilmaz, Lake Orion, MI (US)

(21) Appl. No.: 18/301,029

(22) Filed: Apr. 14, 2023

(51) Int. Cl. B60T 17/22; F16D 66/02

(52) U.S. Cl. CPC B60T 17/22; F16D 66/021; F16D 2066/005

(57) ABSTRACT

A method is for estimating wear for a brake pad of a vehicle, the brake pad being arranged at a wheel end of an axle of the vehicle. The method includes: determining energy inputted for braking at the wheel end for each of a plurality of braking events of the vehicle while the vehicle is moving; determining a brake pad wear caused for each of the plurality of braking events on the basis of the determined energy inputted and at least one of an environmental condition and a load condition; and, determining a total brake pad wear on a basis of the determined brake pad wear for each braking event. The disclosure further relates to a system for estimating the wear of a brake pad, an electronic braking system having such a system, and a vehicle having such a system.

### TECHNICAL FIELD

The disclosure relates to a system for estimating the wear of a brake pad of a vehicle. The disclosure further relates to a method and a system for estimating the wear of a brake pad.

### BACKGROUND

Current systems on the market use lining sensors arranged on the wheel ends of a vehicle to measure the actual pad wear. The systems notify the driver when a predefined threshold for brake wear on a wheel end is reached, typically using a threshold of 95% pad wear. Such systems have high costs resulting from the lining sensors, the wiring, and installation time.

Inherently a system related failure, for example brakes, transmission, engine, driveline, etc., causes downtime for trucks/tractors and trailers, incurs repair costs and thus increases maintenance costs.

U.S. Pat. No. 10,800,393 discloses monitoring the conditions of a service brake of a vehicle via lining sensors which measure pad wear. Such a method requires the installation and wiring of lining sensors.

U.S. Pat. No. 10,773,702 B2 discloses a method and apparatus for estimating brake wear. The brake wear estimation includes determining a speed at a start of a braking action and a speed change of the vehicle during the braking action.

### SUMMARY

It is an object of the disclosure to provide a method for estimating brake pad wear.

The aforementioned object is, for example, achieved via a method for estimating wear for a brake pad of a vehicle, the brake pad being arranged at a wheel end of an axle of the vehicle. The method includes: determining energy inputted for braking at the wheel end for each of a plurality of braking events of the vehicle while the vehicle is moving; determining a brake pad wear caused for each of the plurality of braking events on the basis of the determined energy inputted and at least one of an environmental condition and a load condition; and, determining a total brake pad wear on a basis of the determined brake pad wear for each braking event.

Brake pad wear estimation based on energy input decreases the components required as a result of lining sensors not being needed for determining the brake pad wear. The omission of the lining sensors, the wiring or other connections for the integration thereof, reduces installation times and costs.

According to various embodiments, the determining energy inputted for braking at the wheel end includes measuring at least one of brake pressure, active brake time, cooling time, braking profile, and at least one brake component temperature.

According to various embodiments, the at least one brake component temperature includes at least one of a brake drum temperature and a brake disc temperature.

According to various embodiments, the determining energy inputted includes determining average brake pressure applied, effective braking time, and vehicle speed reduction.

According to various embodiments, the determining energy inputted is further based on a predetermined pressure factor.

According to various embodiments, the method further includes displaying a notification to an operator or a server when the determined total brake pad wear exceeds a maximum brake pad wear threshold.

According to various embodiments, the method further includes determining the environmental condition on a basis of a brake component temperature, an ambient temperature, and a brake activation frequency.

According to various embodiments, the determining the environmental condition is further based on a predetermined environmental factor.

According to various embodiments, the method further includes determining the load condition on a basis of at least one of an axle load of the axle, a dynamic load shift, and a load factor.

According to various embodiments, the method further includes determining a tendency to lock when a braking friction at the wheel is lower than at other wheels of the vehicle by a predetermined threshold; and, reducing a pressure in a brake chamber associated with the wheel when the tendency to lock is determined at the wheel.

According to various embodiments, a lower friction at the wheel is determined via a comparison of an individual wheel speed at the wheel with an average reference speed calculated from individual wheel speeds of all wheels monitored by a braking system.

It is a further object of the disclosure to provide a system for estimating brake pad wear. The aforementioned object is, for example, achieved via a pad wear estimation system for estimating wear for a brake pad of a vehicle, the brake pad being arranged at a wheel end of an axle of the vehicle. The system includes a control unit including a non-transitory storage medium having program code stored thereon; the control unit being configured to determine energy inputted for braking at the wheel end for each of a plurality of braking events of the vehicle while the vehicle is moving; the control unit being further configured, via the program code, to determine a brake pad wear caused for each of the plurality of braking events on the basis of the determined energy inputted and at least one of an environmental condition and a load condition; and, the control unit being further configured to determine a total brake pad wear on a basis of the determined brake pad wear for each braking event.

According to various embodiments, the control unit is configured to receive measurement data of at least one of a brake pressure, an active brake time, a cooling time, a braking profile, and a brake component temperature in order to determine energy inputted for braking at the wheel end.

According to various embodiments, the control unit is configured to determine average brake pressure applied, effective braking time, and vehicle speed reduction so as to determine the energy inputted.

According to various embodiments, the control unit is configured to display a notification to an operator or a server when the determined total brake pad wear exceeds a maximum brake pad wear threshold.

According to various embodiments, the control unit is configured to determine the environmental condition on a basis of a brake component temperature, an ambient temperature, and a brake activation frequency.

According to various embodiments, the control unit is configured to determine the environmental condition further based on a predetermined environmental factor.

According to various embodiments, the control unit is further configured to determine the load condition on a basis of at least one of an axle load of the axle, a dynamic load shift, and a load factor.

According to various embodiments, the control unit is further configured to reduce the pressure in a brake chamber when a tendency to lock is determined at the wheel associated with the brake chamber, wherein the tendency to lock is determined when a braking friction at the wheel is lower than at other wheels of the vehicle by a predetermined threshold.

According to various embodiments, a lower friction at the wheel is determined by the control unit via a comparison of an individual wheel speed at the wheel with an average reference speed calculated from individual wheel speeds of all wheels monitored by a braking system.

It is a further object to provide an electronic braking system having a pad wear estimation system as disclosed herein.

It is a further object to provide a vehicle having a pad wear estimation system as disclosed herein.

### BRIEF DESCRIPTION OF DRAWINGS

The invention will now be described with reference to the drawings wherein:

FIG. 1 shows an EBS system having a system for estimating brake pad wear according to the disclosure; and,

FIG. 2 shows a flow chart of a method according to the disclosure.

FIG. 3 shows a flow chart of a further method according the disclosure; and,

FIG. 4 shows the method of FIG. 2 with additional steps for determining a tendency to lock and avoiding the same.

### DETAILED DESCRIPTION

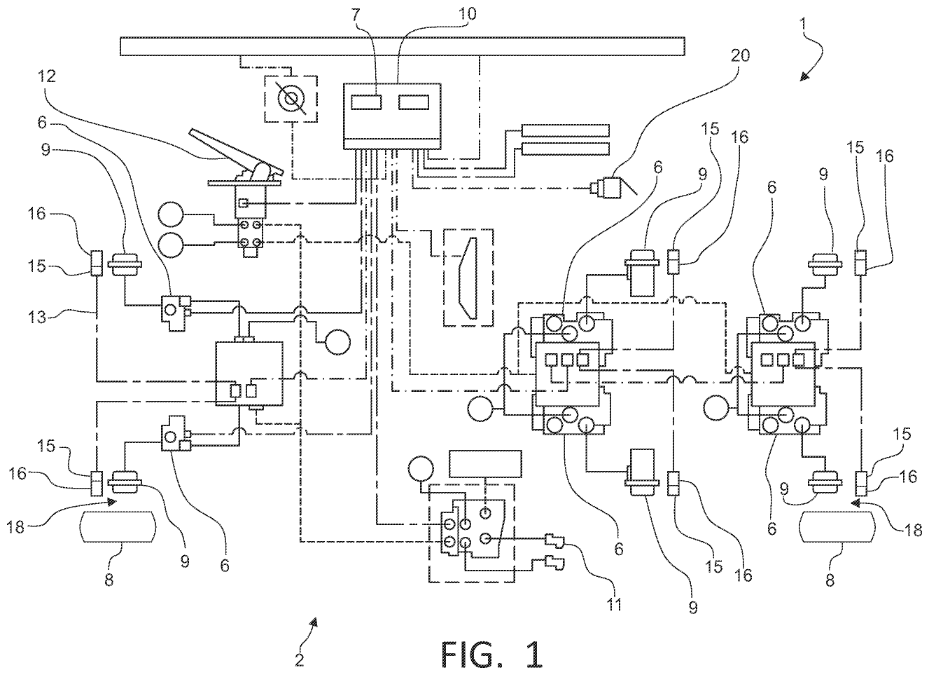

FIG. 1 shows an electronic braking system 1 of a vehicle 2. The vehicle 2 in FIG. 1 is, for example, a truck. The vehicle 2 can further be configured to have a trailer attached thereto and have trailer towing capability. Each wheel 8 of the vehicle 2 has an active wheel speed sensor 16. The electronic braking system 1 includes an electronic braking system (EBS) control unit 10. The control unit 10 is connected to the active wheel speed sensors 16, for example, via electrical connecting lines 13. The EBS control unit 10 monitors the wheel speeds of the wheels 8 via the active wheel speed sensors 16. The number of active wheel speed sensors 16 depends on the configuration of the vehicle 2 and the vehicle's electronic braking system 1. The electronic braking system 1 activates a modulator valve 6 in order to control the pressure in an associated braking chamber 9 for braking a corresponding wheel 8.

The EBS control unit 10 controls the pressure in the respective braking chambers 9 in order to meet a driver deceleration/braking request. If the EBS control unit 10 detects a tendency to lock at a specific wheel 8, the pressure in the relevant brake chamber 9 can be controlled to reduce the risk of locking. A tendency to lock can be determined at a wheel where the friction is lower in comparison with the other wheels 8 monitored by the EBS control unit 10. The lower friction at a wheel of the vehicle can be determined on the basis of a comparison of the wheel speed of the wheel with the average reference speed as calculated from the individual wheel speeds of all the wheels monitored by the electronic braking system 1. The individual wheel speeds can be detected by the active wheel speed sensors 16. If a tendency to lock is detected, preventing a locking of the brake takes priority over the driver's deceleration/braking request. In order to detect a tendency to lock, the wheel speed of each of wheel 8 and the pressure in each of the brake chambers 9 is measured and processed in the brake management module of the EBS control unit 10 which is used for controlling the brake force distribution in the electronic braking system 1. In order to reduce the risk of locking, the pressure in a brake chamber associated with a brake determined to have a tendency to lock is reduced. The active wheel speed sensors 16 can include temperature sensors 15 which provide wheel end temperatures for the wheels 8 to the EBS control unit 10.

The vehicle 2 can include a trailer. The EBS control unit 10 can be connected to wheel speed sensors and the like via a trailer control connection 20. The electronic braking system 1 can supply braking pressure to the trailer via trailer connection 11. The electronic braking system 1 can, for example, be activated by an operator via a pedal 12.

The electronic braking system 1 includes brake pad wear estimation module 7, for example integrated into the EBS control unit 10. The brake pad wear estimation module 7 is configured to estimate the brake pad wear at the individual wheels 8 based on an energy input such as brake pressure, active brake time/duration, cooling time, braking profile, actual brake component temperature (such as of the brake disc and/or brake drum), axle load, vehicle speed, and environmental conditions such as ambient temperature. The electronic braking system 1 having such a brake pad wear estimation module 7 does not require lining sensors to detect the brake pad wear and the required number of components are reduced. This, in turn, reduces installation time of the electronic braking system 1 in the production line or end of line. A high accuracy of the brake pad wear estimation by the brake pad wear estimation module 7 can be achieved as a result of using measurement values relating to the brake energy inputted as the values directly relate to the actual pad wear.

According to various embodiments, conventional electronic braking systems can be supplemented with a brake pad wear estimation module 7. The brake pad wear estimation module can use sensors or other data sources of an electronic braking system as inputs for determining the energy inputted to a particular brake pad by the electronic braking system 1.

According to various embodiments, the estimated brake pad wear is displayed to the operator of the vehicle 2, for example, via a screen or an indicator on the dashboard. If a predetermined threshold is reached or exceeded, the driver can be notified via a visual and/or auditory notification. Enabling the operator to view the brake wear level in a screen or other indicator enables the operator to check the wear on demand and, for example, can be used in determining when maintenance should be performed and what distances/routes can be traveled prior to replacing a brake pad.

According to various embodiments, the temperature sensors 15 integrated in the active wheel speed sensors 16 are used to determine the temperature of the brake components such as the brake drum and the brake disc at the wheel end 18 of the corresponding active wheel speed sensor 16.

According to various embodiments, the axle load, the dynamic load shift, brake pressure gradient, vehicle speed, and outside temperature are all considered in estimating the brake pad wear. Energy input, such as applied brake pressure, can be monitored continuously while driving and directly measured and processed for calculating the brake pad wear.

According to various embodiments, measuring energy inputted during a brake event includes determining active braking, for example via: Active braking_1−n=(applied average brake pressure/effective braking time×vehicle speed reduction)×pressure factor. The load conditions during the active braking are considered in determining the energy inputted during the braking event, that is, the load effecting each axle and the dynamic load shift during the active braking are taken into account. The load condition can, for example, be determined via: Load condition=(actual axle load (before braking)±dynamic load shift (wheelbase and HCG))×load factor. Further, taking the environmental conditions during active braking into account can further increase the accuracy of the estimation of the brake pad wear. The environmental condition can, for example, be determined as follows: Environmental condition=(brake component temp/outside temperature)×brake activation frequency×environmental factor. Finally, the energy inputted during the brake event is determined, for example, via: Brake event_1−n=Active braking_1−n+Load condition_1−n+Environmental conditions_1−n. As brake events when the vehicle is not moving do not cause significant wear on the brake pads, brake events when the vehicle 2 is not moving do not need to be measured or stored. Pressure factors, load factors and environmental factors are to be defined based on field data and can be stored in a computer readable memory, for example a memory unit of the electronic braking system's control unit 10. Further, data regarding the brake pad and wheel end brake type/variant can be also stored and taken into account when making the brake pad wear estimation.

In order to estimate brake pad wear the energy inputted during each relevant braking event is summed (Pad wear on wheel end_n [mm]=Brake event_1+Brake event_2+ . . . +Brake event_n). Each brake event can, for example, be stored as wear, for example, in millimeters. A brake pad wear percentage estimation can be determined by dividing the determined brake pad wear in millimeters over the total pad thickness in millimeters (Pad wear on wheel end_n [%]=Pad wear on wheel end_n [mm]/total pad thickness×100). If the pad wear percentage on a wheel end exceeds a predetermined percentage, for example, 95% on a single wheel end, then the system can notify the driver of the pad wear including which brake pad has the excessive wear.

According to a further embodiment, the actual pad wear percentages on the wheel ends between left and right on the same axle as well as between the front and rear axles are compared and if the difference is greater than a predefined threshold, the system can notify the operator or, for example, a server. For example, if the difference between the lowest and highest value is 25%, then the system will notify the driver with displayed respective wheel end positions.

When the brake pads are renewed, the system is reset. The system can, for example, perform an axle-wise reset, that is, the system is reset for only one axle if the pads on only one axle are replaced.

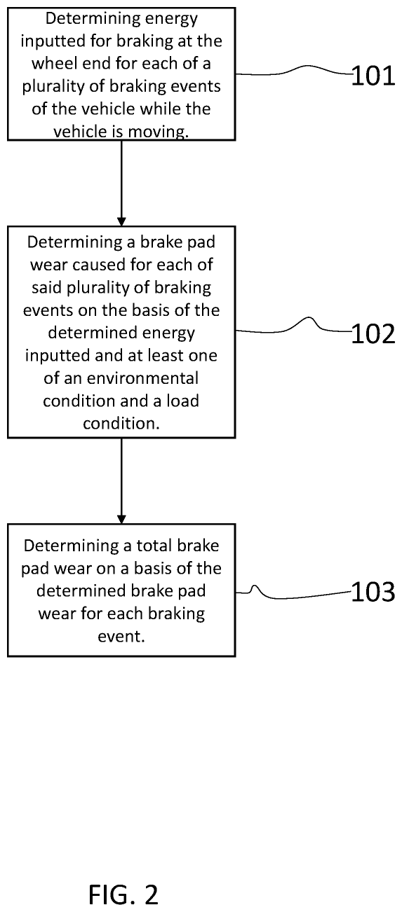

FIG. 2 shows an embodiment of a method according to the disclosure. The energy inputted at a wheel end for each braking event is determined in step 101. The energy inputted is determined for each wheel end associated with a brake pad for which wear is to be estimated. The determination of energy inputted can be omitted if the vehicle is not in motion as no significant wear would be generated when the brakes are applied and the vehicle is not in motion. In a further step 102, an amount of wear is determined for each braking event. The wear caused by the braking event is calculated on the basis of the amount of energy inputted as determined in step 101 and an environmental condition and/or a load condition. In step 103, a total brake pad wear is determined on the basis of the determined brake pad wear for each of the braking events. The wear caused by each of the braking events is summed in order to the determination of the total pad wear. The summation is performed for each of the brake pads for which the wear is being estimated.

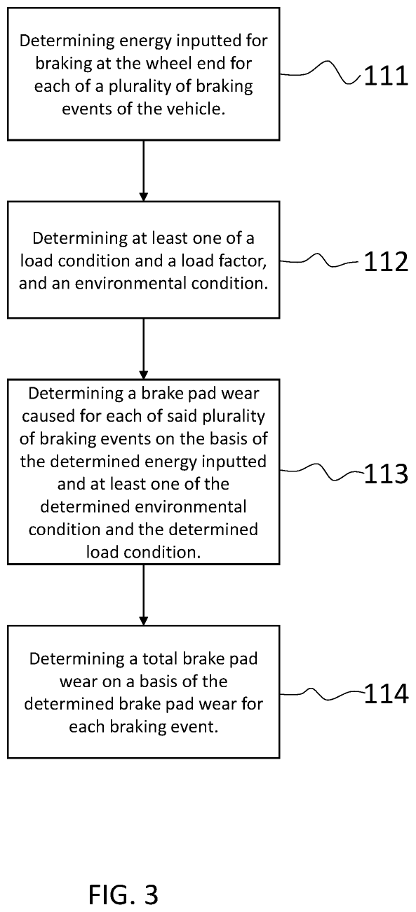

FIG. 3 shows a further embodiment of a method according to the invention. In the method according to FIG. 3, the energy inputted is determined for each braking event in step 111. A load factor and load condition and/or an environmental factor is determined in step 112. The amount of pad wear caused for each braking event is determined in step 113. The load factor and load condition and/or the environmental condition are used to determine the brake pad wear caused by each braking event. The total brake pad wear is determined in step 114 as a sum of the pad wear determined for each braking event.

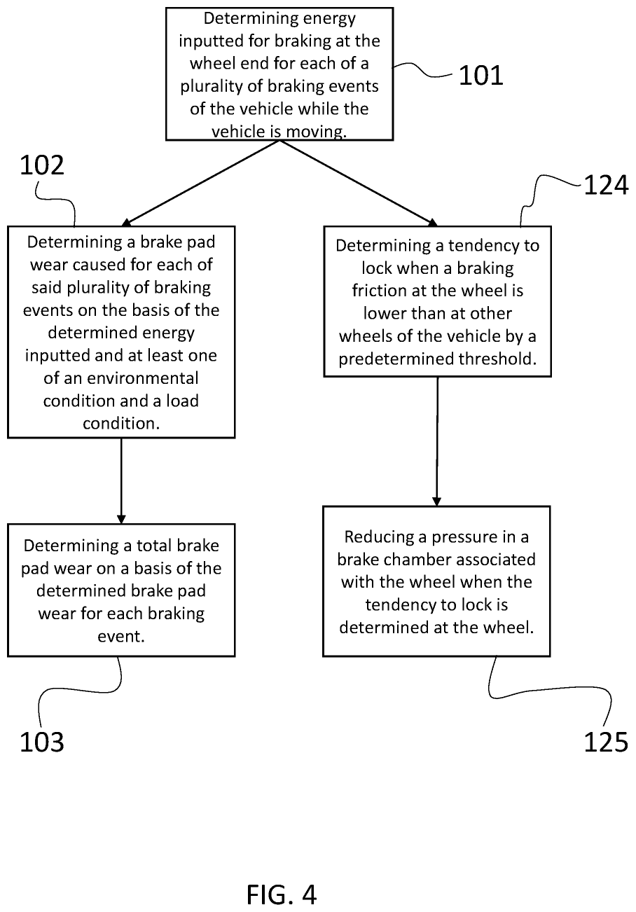

FIG. 4 shows a further embodiment of the method according to the disclosure. The method includes steps 101, 102, and 103 of FIG. 2 and further includes determining a tendency of a brake to lock while braking in step 124. A tendency to lock can be determined when the braking friction at one wheel is lower than at other wheels of the vehicle. According to various embodiments, the tendency to lock is determined when the braking friction of one wheel is lower than that of other wheels by more than a predetermined threshold. If a tendency to lock is determined in step 124, the pressure in the brake chamber associated with the brake having the tendency to lock is reduced so as to avoid a locking of the brake in step 125.

It is understood that the foregoing description is that of the preferred embodiments of the invention and that various changes and modifications may be made thereto without departing from the spirit and scope of the invention as defined in the appended claims.

### LIST OF REFERENCE NUMERALS

1 electronic braking system (EBS)
2 vehicle
6 modulator valve
7 brake pad wear estimation module
8 wheel
9 brake chambers
10 EBS control unit
11 trailer connection
12 pedal
13 electrical connecting lines
15 temperature sensors
16 wheel speed sensors
18 wheel end
20 trailer control connection
101 method step
102 method step
103 method step
111 method step
112 method step
113 method step
114 method step
124 method step
125 method step

1. A method for estimating wear for a brake pad of a vehicle, the brake pad being arranged at a wheel end of an axle of the vehicle, the method comprising:
determining energy inputted for braking at the wheel end for each of a plurality of braking events of the vehicle while the vehicle is moving;
determining a brake pad wear caused for each of said plurality of braking events on the basis of the determined energy inputted and at least one of an environmental condition and a load condition; and,
determining a total brake pad wear on a basis of the determined brake pad wear for each braking event.

2. The method of claim 1, wherein said determining energy inputted for braking at the wheel end includes measuring at least one of brake pressure, active brake time, cooling time, braking profile, and at least one brake component temperature.

3. The method of claim 2, wherein the at least one brake component temperature includes at least one of a brake drum temperature and a brake disc temperature.

4. The method of claim 1, wherein said determining energy inputted includes determining average brake pressure applied, effective braking time, and vehicle speed reduction.

5. The method of claim 4, wherein said determining energy inputted is further based on a predetermined pressure factor.

6. The method of claim 1 further comprising displaying a notification to an operator or a server when the determined total brake pad wear exceeds a maximum brake pad wear threshold.

7. The method of claim 1 further comprising determining the environmental condition on a basis of a brake component temperature, an ambient temperature, and a brake activation frequency.

8. The method of claim 7, wherein said determining the environmental condition is further based on a predetermined environmental factor.

9. The method of claim 1 further comprising determining the load condition on a basis of at least one of an axle load of the axle, a dynamic load shift, and a load factor.

10. The method of claim 1 further comprising:
determining a tendency to lock when a braking friction at the wheel is lower than at other wheels of the vehicle by a predetermined threshold; and,
reducing a pressure in a brake chamber associated with the wheel when the tendency to lock is determined at the wheel.

11. The method of claim 10, wherein a lower friction at the wheel is determined via a comparison of an individual wheel speed at the wheel with an average reference speed calculated from individual wheel speeds of all wheels monitored by a braking system.

12. A pad wear estimation system for estimating wear for a brake pad of a vehicle, the brake pad being arranged at a wheel end of an axle of the vehicle, the system comprising:
a control unit including a non-transitory storage medium having program code stored thereon;
said control unit being configured to determine energy inputted for braking at the wheel end for each of a plurality of braking events of the vehicle while the vehicle is moving;
said control unit being further configured, via said program code, to determine a brake pad wear caused for each of said plurality of braking events on the basis of the determined energy inputted and at least one of an environmental condition and a load condition; and,
said control unit being further configured to determine a total brake pad wear on a basis of the determined brake pad wear for each braking event.

13. The system of claim 12, wherein said control unit is configured to receive measurement data of at least one of a brake pressure, an active brake time, a cooling time, a braking profile, and a brake component temperature in order to determine energy inputted for braking at the wheel end.

14. The system of claim 13, wherein the brake component temperature includes at least one of a brake drum temperature and a brake disc temperature.

15. The system of claim 12, wherein said control unit is configured to determine average brake pressure applied, effective braking time, and vehicle speed reduction so as to determine the energy inputted.

16. The system of claim 12, wherein said control unit is configured to display a notification to an operator or a server when the determined total brake pad wear exceeds a maximum brake pad wear threshold.

17. The system of claim 12, wherein said control unit is configured to determine the environmental condition on a basis of a brake component temperature, an ambient temperature, and a brake activation frequency.

18. The system of claim 17, wherein said control unit is configured to determine the environmental condition further based on a predetermined environmental factor.

19. The system of claim 12, wherein the control unit is further configured to determine the load condition on a basis of at least one of an axle load of the axle, a dynamic load shift, and a load factor.

20. The system of claim 12, wherein the control unit is further configured to reduce the pressure in a brake chamber when a tendency to lock is determined at the wheel associated with the brake chamber, wherein said tendency to lock is determined when a braking friction at the wheel is lower than at other wheels of the vehicle by a predetermined threshold.

21. The system of claim 20, wherein a lower friction at the wheel is determined by said control unit via a comparison of an individual wheel speed at the wheel with an average reference speed calculated from individual wheel speeds of all wheels monitored by a braking system.

22. An electronic braking system for a vehicle, the electronic braking system comprising the pad wear estimation system of claim 12.

23. A vehicle comprising the electronic braking system of claim 22.
